(19) United States
(12) Patent Application Publication
(10) Pub. No.: US 2025/0296729 A1
(43) Pub. Date: Sep. 25, 2025

(54) CARTON LINER CLOSURE & METHODS

(71) Applicant: Reynolds Presto Products Inc., Lake Forest, IL (US)

(72) Inventors: Nicholas A. DeRue, Farmington, NY (US); John D. Athans, Victor, NY (US)

(21) Appl. No.: 19/087,872

(22) Filed: Mar. 24, 2025

Related U.S. Application Data
(60) Provisional application No. 63/568,657, filed on Mar. 22, 2024.
(60) Provisional application No. 63/655,818, filed on Jun. 4, 2024.

(51) Int. Cl. B65D 5/60; B65D 33/25

(52) U.S. Cl. CPC B65D 5/60; B65D 33/2508

(57) ABSTRACT

A package has a carton with a liner with a recloseable closure. The package is shippable as a relatively flat carton blank.

### RELATED APPLICATIONS

This application claims priority to U.S. Provisional Patent Application No. 63/568,657, filed Mar. 22, 2024 and to U.S. Provisional Patent Application No. 63/655,818, filed Jun. 6, 2024, the entireties of which are incorporated by reference herein.

### TECHNICAL FIELD

This disclosure concerns packaging. In particular, this disclosure concerns a liner for a cardboard carton, in which the liner has a resealable closure; the carton with the liner may be flattened for shipping.

### BACKGROUND

Packages containing household products are typically purchased, stored, retrieved, opened, and reclosed until the contents are depleted. Common packages found in households include cartons and flexible bags. Some of these cartons and bags have dispensing features that make it easier for users to access and retrieve the products contained in the packages. In recent years, hybrid structures that contain a flexible inner liner and an outer cardboard box with dispensing features have appeared in the market. See for example, U.S. Pat. No. 10,124,947, Carton with Dispensing Features and U.S. Pat. No. 10,961,014, Carton with Liner describing such hybrid structures. These hybrid packages afford the advantage of providing a suitable barrier liner material for each product in combination with the outer box damage protection from transit and in-store damage. It is difficult to open and reclose existing hybrid packages and dispense their contents.

Improvements in these types of packages are desirable.

### SUMMARY

A package is provided that improves the prior art.

In one aspect, a blank arrangement for a carton and liner is provided; the blank arrangement comprising: (a) a surrounding cardboard wall enclosing an interior volume; the cardboard wall having parallel front and rear panels, and parallel first and second side panels extending between the front and rear panels; each of the front, rear, first side and second side panels having an interior surface facing the interior volume; (b) a tubular liner having an liner exterior surface and opposite liner interior surface; the exterior surface of the liner being attached to the interior surface of each of the front, rear, first side and second side panels; the tubular liner having a first terminal end; the tubular liner having opposing first and second liner walls; and (c) a mated recloseable closure attached at or adjacent to the first terminal end of only the first liner wall and being free from attachment to the second liner wall.

Preferably, the closure is a zipper closure having a slider device attached thereto, constructed and arranged to close the zipper closure, as the slider device is moved in a closing direction along the zipper closure; and open the zipper closure, as the slider device is moved in an opening direction along the zipper closure.

In some arrangements, the closure is a press-to-close zipper closure and is slider-free.

In some embodiments, the closure is a hook and loop fastener.

Preferably, the mated closure is attached to the liner interior surface of the first liner wall.

In some embodiments, the opposing first and second liner walls are separate walls secured together along opposite first and second side seams.

Preferably, the front panel and first side panel have a bendable corner A therebetween; the front panel and the second side panel have a bendable corner B therebetween; the rear panel and the second side panel have a bendable corner C therebetween; the rear panel and the first side panel have a bendable corner D therebetween; wherein the blank arrangement is constructed to be relatively flat with bendable corners B and D at opposite ends of the blank arrangement, with bendable corner C nearer to B than D; and with bendable corner A nearer D than B; and the mated recloseable zipper closure is relatively straight and free of folds from adjacent bendable corner B extending at least partially toward bendable corner D.

Preferably, the mated recloseable closure extends from adjacent bendable corner B, across bendable corners C and A, and ends before reaching bendable corner D.

In example embodiments, the surrounding cardboard wall has a bottom panel.

In example embodiments, the liner has a closed bottom between the opposing first and second liner walls.

In another aspect, a method of packaging is provided; the method comprising: (a) providing a relatively flat blank arrangement; the blank arrangement including, (i) a surrounding cardboard wall enclosing an interior volume; the cardboard wall having parallel front and rear panels, and parallel first and second side panels extending between the front and rear panels; each of the front, rear, first side and second side panels having an interior surface facing the interior volume; a tubular liner having an liner exterior surface and opposite liner interior surface; the exterior surface of the liner being attached to the interior surface of each of the front, rear, first side and second side panels; the tubular liner having a first terminal end; the tubular liner having opposing first and second liner walls; a mated recloseable closure attached at or adjacent to the first terminal end of only the first liner wall and being free from attachment to the second liner wall; the front panel and first side panel have a bendable corner A therebetween; the front panel and the second side panel have a bendable corner B therebetween; the rear panel and the second side panel have a bendable corner C therebetween; the rear panel and the first side panel have a bendable corner D therebetween; bendable corners B and D being at opposite ends of the blank arrangement, with bendable corner C nearer to B than D; and with bendable corner A nearer D than B; and the mated recloseable closure being relatively straight and free of folds from adjacent bendable corner B extending at least partially toward bendable corner D; bending corners A, B, C, and D to form a rectangular tube with an open interior and an open top and bottom; forming a closure at the bottom; providing filling material into the open interior; and attaching the mated recloseable closure to the second liner wall to close the first terminal end of the tubular liner.

Some methods further include, after closing the first terminal end of the tubular liner, forming a closure at the top of the rectangular tube.

In some embodiments, the step of providing a relatively flat blank arrangement includes the mated recloseable closure being a recloseable zipper closure having male and female mating profiles.

In some embodiments, the recloseable zipper closure has a slider device attached thereto, constructed and arranged to close and open the zipper closure, as the slider device is moved along the zipper closure.

In some methods, the step of providing a relatively flat blank arrangement includes the mated recloseable closure is a hook and loop fastener.

In another aspect, a method of using a recloseable package is provided. The method comprising: providing a closed carton having a liner in an interior of the carton; opening an end of the carton to access the interior; opening a recloseable closure on the liner to access contents within the liner; and closing the recloseable closure on the liner.

Preferably, the step of opening the recloseable closure includes opening a recloseable zipper closure.

Preferably, the step of opening a recloseable zipper closure includes moving a slider device along the zipper closure.

In some methods, the step of opening the recloseable closure includes opening a recloseable hook and loop closure.

In another aspect, a package blank for a carton and liner is provided. The package blank comprises: (a) a surrounding cardboard wall enclosing an interior volume; the cardboard wall having parallel front and rear panels, and parallel first and second side panels extending between the front and rear panels; each of the front, rear, first side and second side panels having an interior surface facing the interior volume; (b) a tubular liner having an exterior surface and opposite liner interior surface; the exterior surface of the liner being attached to the interior surface of each of the front, rear, first side and second side panels; the tubular liner having a first terminal end and an opposite, second terminal end; the tubular liner having opposing first and second liner walls; and (c) a mated recloseable closure attached at or adjacent to the first terminal end of the tubular liner, closing the first terminal end; the second terminal end being open.

In example embodiments, (a) the first side panel having a bendable foldline A dividing the first side panel between a first side panel first section and a first side panel second section; (b) the second side panel having a bendable foldline B dividing the second side panel between a second side first panel section and a second side panel second section; (c) the front panel and first side panel first section have a bendable foldline C therebetween; (d) the front panel and the second side panel first section have a bendable foldline D therebetween; (e) the rear panel and the first side panel second section have a bendable foldline E therebetween; and (f) the rear panel and the second side panel second section have a bendable foldline F therebetween; wherein the package blank is constructed to be relatively flat with bendable foldlines A and B at opposite ends of the package blank, and the mated recloseable zipper closure is relatively straight and free of folds from adjacent bendable foldline A extending completely to bendable foldline B.

In one or more arrangements, the closure is a zipper closure having a slider device attached thereto, constructed and arranged to close the zipper closure, as the slider device is moved in a closing direction along the zipper closure; and open the zipper closure, as the slider device is moved in an opening direction along the zipper closure.

In some embodiments, the closure is a press-to-close zipper closure and is slider-free.

In some implementations, the closure is a hook and loop fastener.

In examples, the opposing first and second liner walls are separate walls secured together along opposite first and second side seams.

In one or more embodiments, the surrounding cardboard wall has a plurality of upper flaps, foldable into a closeable top; and a plurality of lower flaps, foldable into a closeable bottom.

In another aspect, a method of packaging is provided. The method comprising: (a) providing a relatively flat package blank; the package blank including, (i) a surrounding cardboard wall enclosing an interior volume; the cardboard wall having parallel front and rear panels, and parallel first and second side panels extending between the front and rear panels; each of the front, rear, first side and second side panels having an interior surface facing the interior volume; (ii) a tubular liner having an liner exterior surface and opposite liner interior surface; the exterior surface of the liner being attached to the interior surface of each of the front, rear, first side and second side panels; the tubular liner having a first terminal end and an opposite second terminal end; the tubular liner having opposing first and second liner walls; (iii) a mated recloseable closure attached at or adjacent to the first terminal end of the tubular liner, closing the first terminal end; (iv) the first side panel having a bendable foldline A dividing the first side panel between a first side panel first section and a first side panel second section; the second side panel having a bendable foldline B dividing the second side panel between a second side first panel section and a second side panel second section; the front panel and first side panel first section have a bendable foldline C therebetween; the front panel and the second side panel first section have a bendable foldline D therebetween; the rear panel and the first side panel second section have a bendable foldline E therebetween; and the rear panel and the second side panel second section have a bendable foldline F therebetween; (b) bending foldlines A, B, C, D, E, and F to form a rectangular tube with an open interior and an open top and bottom; (c) forming a closure at the top; (d) providing filling material into the open interior through the open bottom; and (e) forming a closure at the bottom.

In example methods, the step of providing a relatively flat package blank includes the mated recloseable closure being a recloseable zipper closure having male and female mating profiles.

In example methods, the recloseable zipper closure has a slider device attached thereto, constructed and arranged to close and open the zipper closure, as the slider device is moved along the zipper closure.

In another aspect, a blank arrangement for a carton and liner is provided; the blank arrangement comprising: (a) a surrounding cardboard wall enclosing an interior volume; the cardboard wall having parallel front and rear panels, and parallel first and second side panels extending between the front and rear panels; each of the front, rear, first side and second side panels having an interior surface facing the interior volume; (b) a tubular liner having an exterior surface and opposite liner interior surface; the exterior surface of the liner being attached to the interior surface of each of the front, rear, first side and second side panels; the tubular liner having a first terminal end and an opposite, second terminal end; the tubular liner having opposing first and second liner walls; and (c) a mated recloseable closure attached at or adjacent to the first terminal end of the tubular liner.

In example embodiments, the mated recloseable closure is closing the first terminal end, and the second terminal end is open.

In one or more embodiments, the mated recloseable closure is attached to the first terminal end of only the first liner wall and being free from attachment to the second liner wall.

It is noted that not all of the specific features described herein need to be incorporated in an arrangement for the arrangement to have some selected advantage according to the present disclosure.

### BRIEF DESCRIPTION OF THE DRAWINGS

FIG. 1 is a perspective, schematic view of a package including a carton with a liner, the liner having a recloseable closure;

FIG. 1A is a perspective, schematic view of the liner used in the package of FIG. 1, viewed from an opposite side as FIG. 1.

FIG. 2. is a blank arrangement, in flat form, used to make the package of FIG. 1;

FIG. 3 is a top view of the carton and liner, during one step of making the package of FIG. 1;

FIG. 4 is a perspective view of the carton and liner of FIG. 3;

FIG. 5 is a top, perspective view of the carton and liner, during another step of making the package of FIG. 1;

FIG. 6 is a top, plan view of the carton and liner, during one step of use;

FIG. 7 is a top view of the carton and liner, during one step of making the package of FIG. 1, analogous to FIG. 3, but showing an alternative embodiment of a recloseable closure;

FIG. 8 is a perspective, schematic view of a second embodiment of a package including a carton with a liner, the liner having a recloseable closure;

FIG. 9 is a top, plan view of the carton and liner of FIG. 8, during one step of use;

FIG. 10 is a top, plan view of a carton blank of the carton of FIG. 8, before the step of having the liner added, and before being folded;

FIG. 11 is a schematic, perspective view of a manufacturing process for adding the liner to the carton blank of FIG. 11;

FIG. 12 is a top plan view of the carton blank with the liner, before the carton and liner are folded flat for shipping; and

FIG. 13 is the carton blank and liner of FIG. 12, in flat form, used to make the package of FIG. 8.

### DETAILED DESCRIPTION

The present disclosure relates to a resealable closure attached to a liner disposed in the interior of a carton with product dispensing features. Typical products include food and household materials that can flow. The carton itself has an access feature for selectively opening and receiving products into its interior. The carton may also haves a flip top to allow the product to be dispensed. The closure in the liner provides a convenient access feature for selectively opening and receiving products into the liner's interior or for opening and dispensing the stored products from its interior.

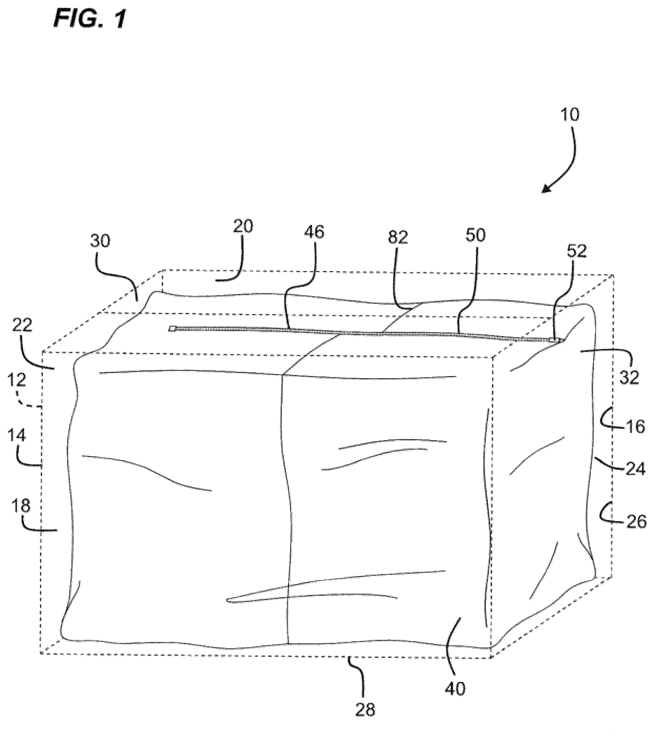

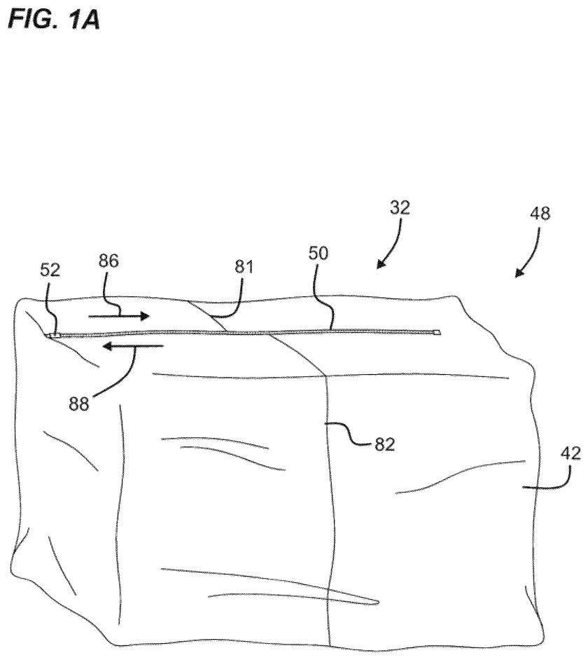

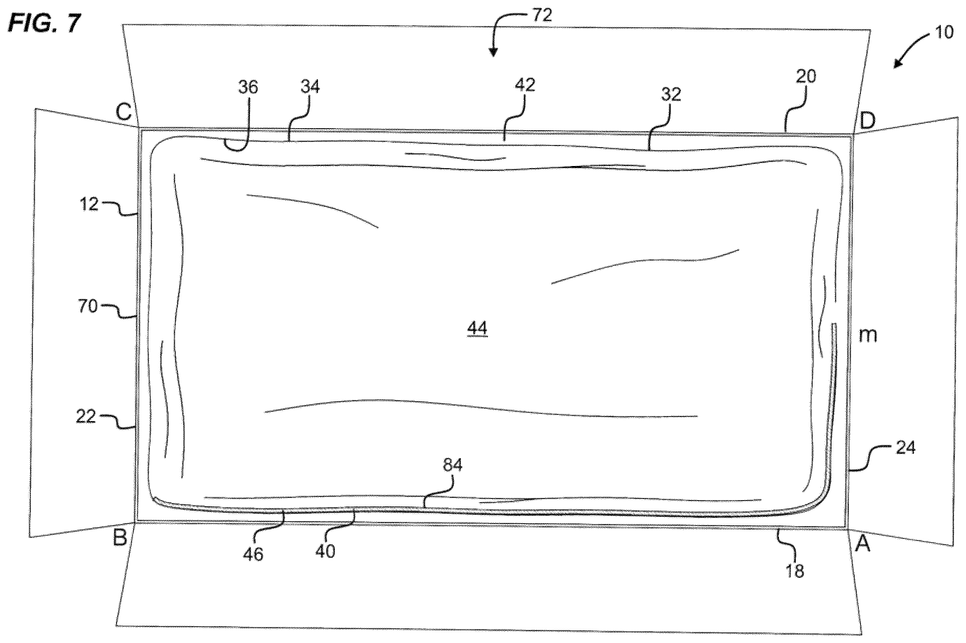

### The Embodiment of FIGS. 1-7

FIG. 1 a perspective, schematic view of a finished package 10, constructed in accordance with principles of this disclosure. The package 10 includes a carton 12, shown schematically in broken lines. The carton 12 is typically made from cardboard, or similar materials. The carton 12 has a surrounding wall 14. The surrounding wall 14 encloses an interior volume 16.

While there may be many variations, in this embodiment, the surrounding wall 14 has a front panel 18 and a parallel rear panel 20. The surrounding wall 14 has a first side panel 22 and a parallel second side panel 24 extending between the front panel 18 and rear panel 20. Each of the front 18, rear 20, first side 22 and second side 24 panels have an interior surface 26 facing the interior volume 16. In FIG. 1, the carton 12 also has a closed bottom 28 and a closed top 30. In this embodiment, the bottom 28 and top 30 are parallel, but in other embodiments, they need not be. In this embodiment, the carton 12 is shaped like a rectangular box, but in other embodiments, it can be other shapes.

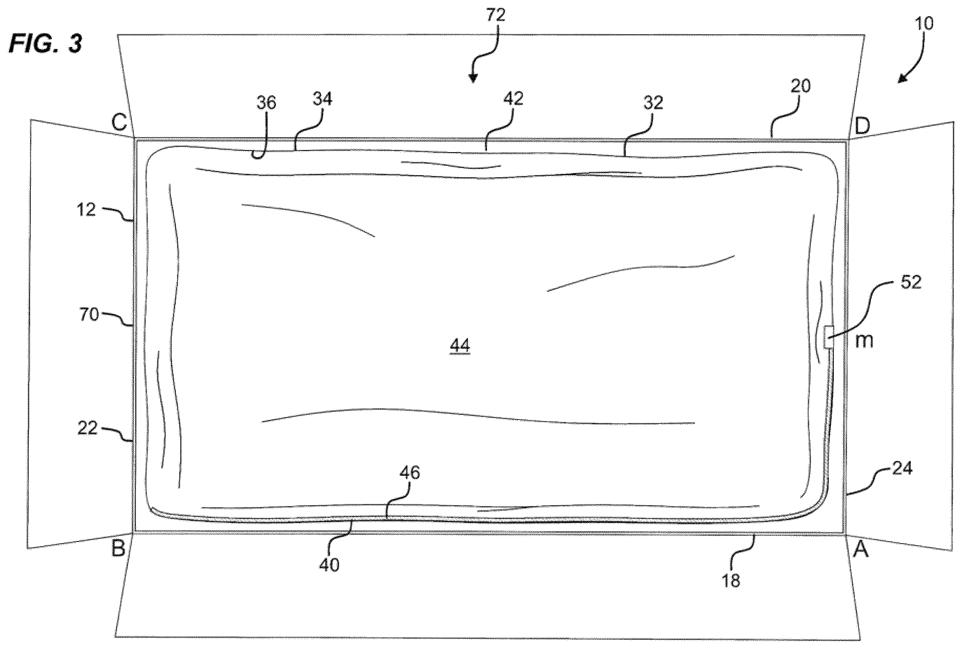

The package 10 includes a tubular liner 32. The liner 32 has a liner exterior surface 34 and a liner interior surface 36 (FIG. 3). The exterior surface 34 of the liner 32 is attached to the interior surface 26 of each of the front 18, rear 20, first side 22 and second side 24 panels. Attachment can be by glue, adhesive, or other suitable attachment means.

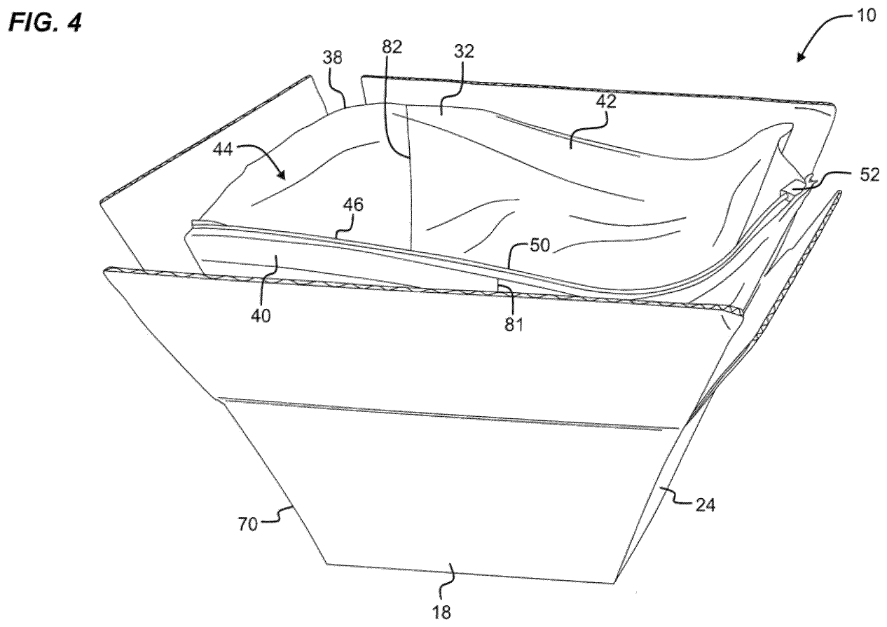

Referring now to FIG. 4, the tubular liner 32 is shown having a first terminal end 38. The tubular liner 32 has opposing first 40 and second 42 liner walls. In this embodiment, the opposing first 40 and second 42 liner walls are separate walls secured together along opposite first and second side seams 81, 82. In other embodiments, the tubular liner 32 can be a single wall formed in a tube with only a single seam; or, the tubular liner can be a single wall, extruded in the shape of a tube. The first 40 and second 42 liner walls define a liner interior volume 44 therewithin.

The liner 32 can be plastic or paper. If paper, the liner 32 will typically include a discrete layer of polypropylene on the interior surface 34 of the liner 32.

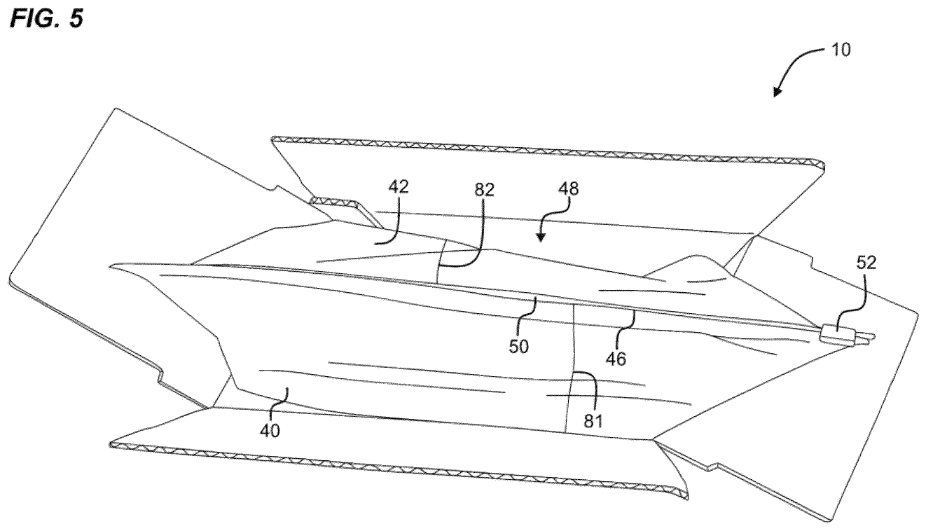

In accordance with principles of this disclosure, the package 10 includes a mated recloseable closure 46. Attention is directed to FIGS. 3 and 4. The recloseable closure 46 is attached at or adjacent to the first terminal end 38 of only the first liner wall 40. The closure 46 is free from attachment to the second liner wall 42. This allows the packager to fill the interior volume 44 of the liner 32, and after, attaching (sealing) the closure 46 to the second liner wall 42 to form a closed pouch 48 (FIGS. 1A and 5) having recloseable closure 46.

The recloseable closure 46 may be embodied in a variety of forms. Preferably, the closure 46 is a recloseable zipper closure 50. The zipper closure 50 is constructed as known in the art, and includes mating male and female profiles.

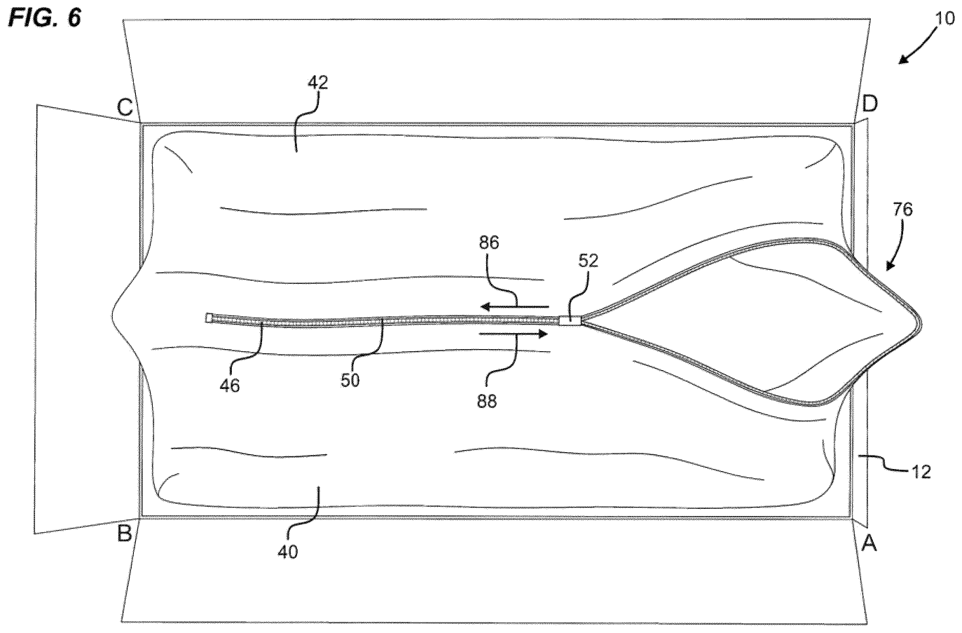

The zipper closure 50 may be a press-to-close closure and slider-free. Or, as shown in the drawings the closure 50 includes a slider device 52 constructed and arranged to close and open the zipper closure, as the slider device 52 is moved along the zipper closure. In FIG. 1A and FIG. 6, arrow 86 shows the direction of movement of the slider device 52 to open the closure 50, and arrow 88 shows the direction of movement of the slider device 52 to close the closure 50. FIG. 1A shows the pouch 48 in a closed condition.

Alternatively, the recloseable closure 46 is a hook and loop closure, or other forms of recloseable closures.

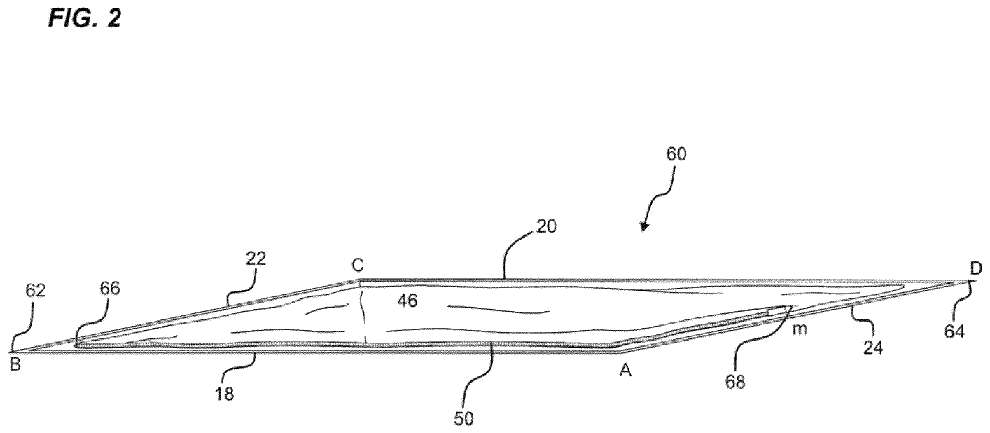

The package 10 may be shipped for filling and finishing as a blank 60 (FIG. 2). The blank 60 is “relatively flat.” By “relatively flat”, it is meant that the blank 60 is not perfectly flat, but has deviations from a perfect flat of no more than 1 inch.

In reference now to FIG. 2, the front panel 18 and first side panel 22 have a bendable corner A therebetween. The front panel 18 and the second side panel 24 have a bendable corner B therebetween. The rear panel 20 and the second side panel 24 have a bendable corner C therebetween. The rear panel 20 and the first side panel 22 have a bendable corner D therebetween. By “bendable corner”, it is meant a pre-formed crease.

In FIG. 2, the blank 60 is constructed to be relatively flat with bendable corners B and D at opposite ends 62, 64 of the blank 60. Bendable corner C is nearer to B than D; and bendable corner A is nearer D than B. From end 62, to end 64, the corners are, in order, B, then C, then A, then D. The mated recloseable closure 46 is relatively straight and free of folds from adjacent bendable corner B extending at least partially toward bendable corner D. In preferred embodiments, the closure 46 has opposite ends 66, 68, and the closure end 68, having slider device 52, is about halfway between corner A and D, shown in FIG. 2 at m.

When the liner 32 is pulled together along the length of the carton 12, it will be in the middle. The placement of closure 46 is such that when the erected carton 12 is collapsed into a flat pack configuration (blank 60), the zipper closure 50 does not get folded over on either end 66, 68. Specifically, the end 68 of the zipper closure 50 cannot extend around corner D into rear panel 20; otherwise, the zipper closure 50 would be folded/creased over when the carton 12 is in the flat pack condition. For the same reason, the end 66 of the closure 50 cannot go past corner B and into side panel 22. A kink in the closure 50 is undesirable, as it could damage the closure 50 and interfere with the subsequent opening and closing of the closure 50.

The blank 60 can be used for a method of packaging. The method includes providing the blank 60, as shown in FIG. 2 and described above. The method includes bending corners A, B, C, and D to form a rectangular tube 70 (FIGS. 3 and 4) with open interior volume 44, and an open top 72 and open bottom.

Next, the method includes forming a closure at the bottom. This can include folding and securing flaps of the carton 12 to form closed bottom 28 (FIG. 1).

Next, the method includes providing filling material into the open interior volume 44. This can include filling with pourable food (pet food or for human consumption), or with any pourable product (e.g. powered laundry detergent, etc.).

Next, the method includes attaching the mated recloseable closure 46 to the second liner wall 42 to close the first terminal end 38 of the liner 32. Attaching can be by heat sealing, or other methods.

Preferably, the method further includes, after closing the first terminal end 38 of the liner 32, forming a closure at the top 72 of the rectangular tube 70 to form the closed top 30.

An alternative method of packaging may also be employed using the blank 60, as shown in FIG. 2 and described above. The method includes bending corners A, B, C, and D to form a rectangular tube 70 (FIGS. 3 and 4) with open interior volume 44, and an open top 72 and open bottom. Next, the method includes attaching the mated recloseable closure 46 to the second liner wall 42 to close the first terminal end 38 of the liner 32. Attaching can be by heat sealing, or other methods. A closure at the top 72 to form the closed top 30 is formed next. Next, the method includes providing filling material into the open interior volume 44, through the open bottom. This can include filling with pourable food (pet food or for human consumption), or with any pourable product (e.g. powered laundry detergent, etc.). A closure can then be formed at the bottom by folding and securing flaps of the carton 12 to form closed bottom 28 (FIG. 1).

In an alternative arrangement, the recloseable closure 46 is attached to the liner 32 after the rectangular tube 70 (FIGS. 3 and 4) is formed, but before the step of filling.

A method of using the package 10 may include opening an end of the carton 10 to access the interior 16. Then, opening the recloseable closure 46 on the liner 32 to access contents within the liner 32. Finally, closing the recloseable closure 46 on the liner 32. In FIG. 6, the closure 46 can be formed to have a dispensing spout 76, by partially opening the closure 46 with the slider device 52.

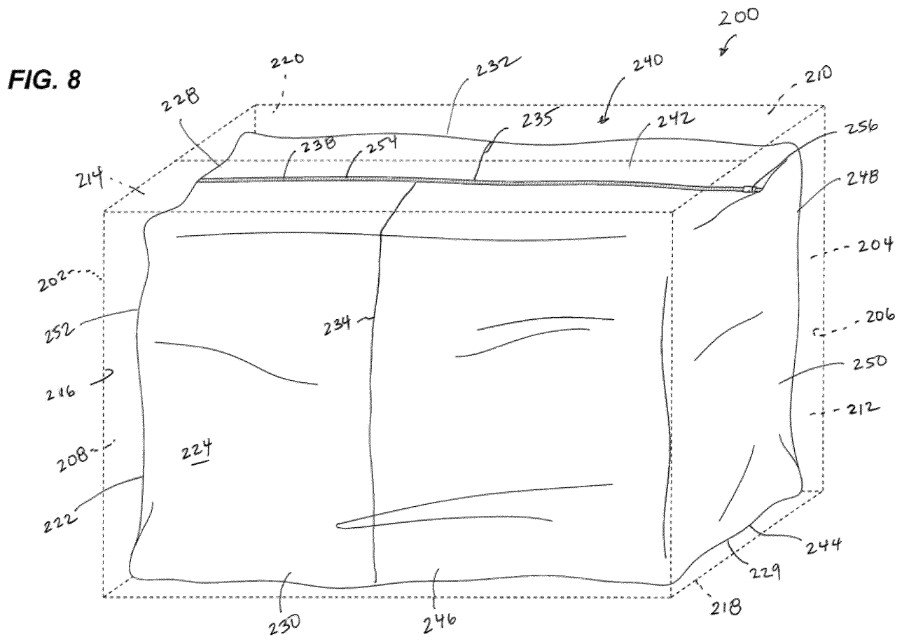

### The Embodiment of FIGS. 8-13

FIG. 8 is a perspective, schematic view of another embodiment of a finished package 200, constructed in accordance with principles of this disclosure. The package 200 includes a carton 202, shown schematically in broken lines. The carton 202 is typically made from cardboard, or similar materials. The carton 202 has a surrounding wall 204. The surrounding wall 204 encloses an interior volume 206.

While there may be many variations, in this embodiment, the surrounding wall 204 has a front panel 208 and a parallel rear panel 210. The surrounding wall 204 has a first side panel 212 and a parallel second side panel 214 extending between the front panel 208 and rear panel 210. Each of the front 208, rear 210, first side 212 and second side 214 panels have an interior surface 216 facing the interior volume 206. In FIG. 8, the carton 202 also has a closed bottom 218 and a closed top 220. In this embodiment, the bottom 218 and top 220 are parallel, but in other embodiments, they need not be. In this embodiment, the carton 202 is shaped like a rectangular box, but in other embodiments, it can be other shapes.

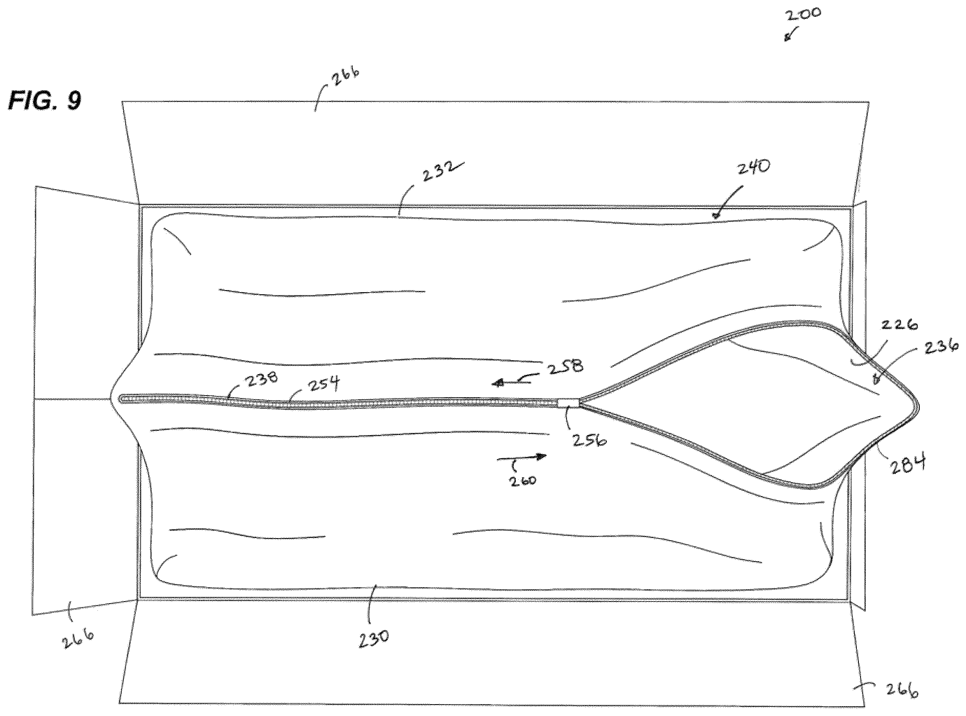

The package 200 includes a tubular liner 222. The liner 222 has a liner exterior surface 224 and a liner interior surface 226 (FIG. 9). The exterior surface 224 of the liner 222 is attached to the interior surface 226 of each of the front 208, rear 210, first side 212 and second side 214 panels. Attachment can be by glue, adhesive, or other suitable attachment means.

The tubular liner 222 has a first terminal end 228 and an opposite second terminal end 229. The tubular liner 222 has opposing first 230 and second 232 liner walls. In this embodiment, the opposing first 230 and second 232 liner walls are separate walls secured together along opposite first and second side seams 234, 235. In other embodiments, the tubular liner 222 can be a single wall formed in a tube with only a single seam; or, the tubular liner can be a single wall, formed in the shape of a tube. The first 230 and second 232 liner walls define a liner interior volume 236 (FIG. 9) therewithin.

The liner 222 can be plastic or paper. If paper, the liner 222 will typically include a discrete layer of polymeric material on the interior surface 224 of the liner 222.

In accordance with principles of this disclosure, the package 200 includes a mated recloseable closure 238. Similar to the embodiment of FIGS. 1-7, the recloseable closure 238 is attached at or adjacent to the first terminal end 228 of the liner 222, but in contrast to the embodiment of FIGS. 1-7, the closure 238 closes the first terminal end 228 and is secured to both the first liner wall 230 and second liner wall 232. The second terminal end 229 may be left as an open end to allow the packager to fill the interior volume 236 of the liner 222, and after, attaching (sealing) the second terminal end 229 closed by attaching the first liner wall 230 to the second liner wall 232, to form a closed pouch 240 having recloseable closure 238.

In FIG. 8, it can be appreciated that when closed pouch 240 is secured within the interior volume 206 of the carton 202, it takes the same general form as the carton 202. As such, the pouch has a closed (but openable) top end 242; opposite closed bottom end 244; front side 246; opposite rear side 248; and opposite first and second sidewalls 250, 252 extending between the top end 242 and bottom end 244.

The recloseable closure 238 extends a full distance along the top end 242 between the first sidewall 250 and second sidewall 252. This is another distinction from the embodiment of FIGS. 1-7, in which the closure 46 of FIGS. 1-7 extends only partially between the sidewalls of the pouch 48.

The recloseable closure 238 may be embodied in a variety of forms. Preferably, the closure 238 is a recloseable zipper closure 254. The zipper closure 254 is constructed as known in the art, and includes mating male and female profiles. The zipper closure 254 may be a press-to-close closure and slider-free. Or, as shown in the drawings, the closure 254 includes a slider device 256 constructed and arranged to close and open the zipper closure 254, as the slider device 256 is moved along the zipper closure 254. In FIG. 9, arrow 258 shows the direction of movement of the slider device 256 to open the closure 254, and arrow 260 shows the direction of movement of the slider device 256 to close the closure 254. FIG. 8 shows the pouch 240 in a closed condition.

Alternatively, the recloseable closure 238 can be a hook and loop closure, or other forms of recloseable closures.

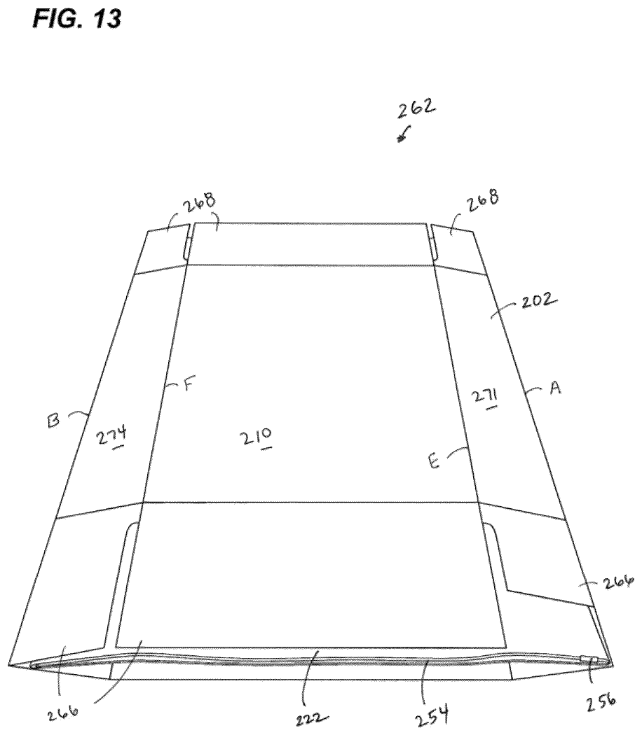

The package 200 may be shipped for filling and finishing as a package blank 262 (FIG. 13). By “package blank”, it is meant the combination of the carton 202 and liner 222, in a form for shipping. The form for shipping means that the package blank 262 is “relatively flat.” By “relatively flat”, it is meant that the blank 262 is not perfectly flat, but has deviations from a perfect flat of no more than 1 inch.

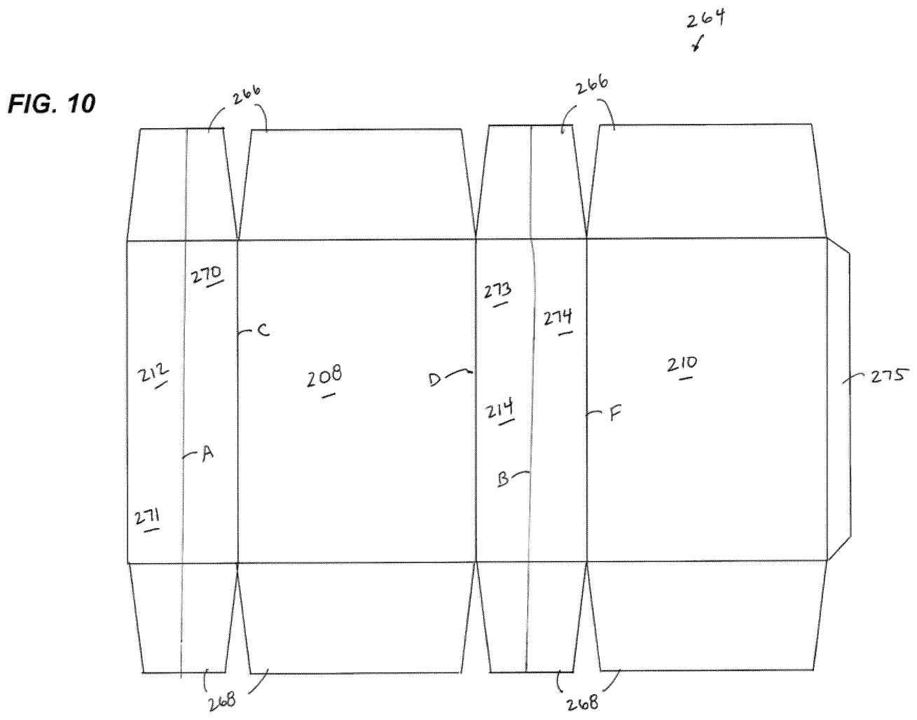

Before the package blank 262 is formed, the carton 202 is in the form of a carton blank 264 (FIG. 10). The carton blank 264 is shown with its front panel 208, rear panel 210, first side panel 212, and second side panel 214 in a flat, unfolded form. The carton blank 264 has a plurality of upper flaps 266, foldable into the carton top 220; and a plurality of lower flaps 268, foldable into the carton bottom 218.

Referring again to FIG. 10, the carton blank 264 includes the first side panel 212 having a bendable foldline A dividing the first side panel 212 between a first side panel first section 270 and a first side panel second section 271. The foldline A extends completely through the first side panel 212, the upper flap 266, and the lower flap 268. The second side panel 214 has a bendable foldline B dividing the second side panel 214 between a second side first panel section 273 and a second side panel second section 274. The foldline B extends completely through the second side panel 214, the upper flap 266, and the lower flap 268. The front panel 208 and first side panel first section 270 have a bendable foldline C therebetween. The front panel 208 and the second side panel first section 273 have a bendable foldline D therebetween. The rear panel 210 and the second side panel second section 274 have a bendable foldline F therebetween. A glue flap 275 is shown along the edge of rear panel 210. After folding, the glue flap 275 is secured to the first side panel second section 271 and formed with a bendable foldline E (FIG. 13).

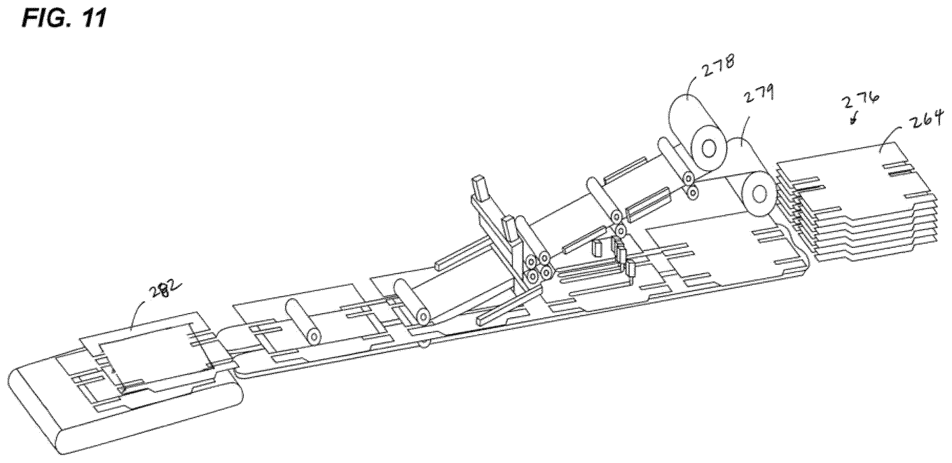

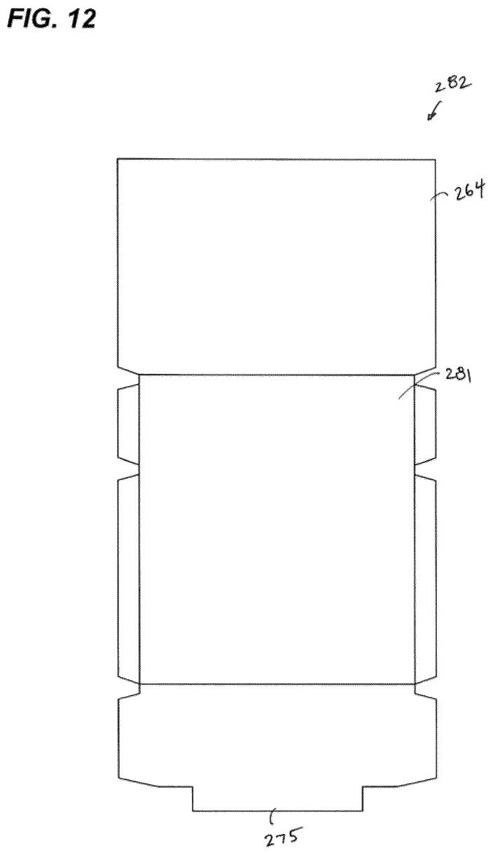

FIG. 11 is a schematic illustration of a process for making the package blank 262. At station 276 is a stack of carton blanks 264. Each carton blank 264 is advanced in the line, while two rolls of film 278, 279 are applied, formed into a tube 281, having the recloseable closure 238 applied to close the first terminal end 228, to result in the package blank 262, but prior to folding, shown as an unfolded package blank 282 (FIG. 12). The unfolded package blank 282 is then folded and secured together along glue flap 275 to result in package blank 262 (FIG. 13)

FIG. 13 shows the package blank 262. The package blank 262 includes the first side panel 212 having bendable foldline A. The second side panel 214 has bendable foldline B dividing the second side panel 214. The front panel 208 and first side panel first section 270 have bendable foldline C therebetween. The front panel 208 and the second side panel first section 273 have bendable foldline D therebetween. The package blank 262 is relatively flat with bendable foldlines A and B at opposite ends of the package blank 262. The mated recloseable zipper closure 254 is relatively straight and free of folds, extending from adjacent bendable foldline A completely to bendable foldline B.

A method of packaging may be practiced, using the above principles. The method includes providing relatively flat package blank 262 including: surrounding cardboard wall 204 enclosing interior volume 206; the cardboard wall 204 having parallel front and rear panels 208, 210, and parallel first and second side panels 212, 214 extending between the front and rear panels 208, 210; tubular liner 222 having exterior surface 226 and opposite interior surface 224; the exterior surface 226 of the liner 222 being attached to the interior surface of each of the front, rear, first side and second side panels 208, 210, 212, 214; the tubular liner having a first terminal end 228 and an opposite second terminal end 229. Mated recloseable closure 238 attached at or adjacent to the first terminal end 228 of the tubular liner 222, closing the first terminal end 228. The blank having foldlines, as described above. The method includes bending foldlines A, B, C, D, E, and F to form a rectangular tube 70 with open interior 206 and open top 220 and bottom 218. Next, the method includes forming closure at the top 220. Next, the method includes providing filling material into the open interior 206 through the open bottom 218. Next, the method includes forming closure at the bottom 218.

A method of using the package 200 may include opening an end of the carton 202 to access the interior 206. Then, opening the recloseable closure 238 on the liner 222 to access contents within the liner 22. Finally, closing the recloseable closure 238 on the liner 222. In FIG. 9, the closure 238 can be formed to have a dispensing spout 284, by partially opening the closure 238 with the slider device 256.

The above represents example principles. Many embodiments can be made using these principles.

What is claimed is:

1. A blank arrangement for a carton and liner; the blank arrangement comprising:
(a) a surrounding cardboard wall enclosing an interior volume; the cardboard wall having parallel front and rear panels, and parallel first and second side panels extending between the front and rear panels; each of the front, rear, first side and second side panels having an interior surface facing the interior volume;
(b) a tubular liner having an exterior surface and opposite liner interior surface; the exterior surface of the liner being attached to the interior surface of each of the front, rear, first side and second side panels; the tubular liner having a first terminal end; the tubular liner having opposing first and second liner walls; and
(c) a mated recloseable closure attached at or adjacent to the first terminal end of only the first liner wall and being free from attachment to the second liner wall.

2. The blank arrangement of claim 1, wherein the closure is a zipper closure having a slider device attached thereto, constructed and arranged to close the zipper closure, as the slider device is moved in a closing direction along the zipper closure; and open the zipper closure, as the slider device is moved in an opening direction along the zipper closure.

3. The blank arrangement of claim 1, wherein the closure is a press-to-close zipper closure and is slider-free.

4. The blank arrangement of claim 1, wherein the closure is a hook and loop fastener.

5. The blank arrangement of claim 1, wherein the mated closure is attached to the liner interior surface of the first liner wall.

6. The blank arrangement of claim 1, wherein the opposing first and second liner walls are separate walls secured together along opposite first and second side seams.

7. The blank arrangement of claim 1, wherein:
(a) the front panel and first side panel have a bendable corner A therebetween;
(b) the front panel and the second side panel have a bendable corner B therebetween;
(c) the rear panel and the second side panel have a bendable corner C therebetween;
(d) the rear panel and the first side panel have a bendable corner D therebetween;
wherein the blank arrangement is constructed to be relatively flat with bendable corners B and D at opposite ends of the blank arrangement, with bendable corner C nearer to B than D; and with bendable corner A nearer D than B; and the mated recloseable zipper closure is relatively straight and free of folds from adjacent bendable corner B extending at least partially toward bendable corner D.

8. The blank arrangement of claim 7, wherein the mated recloseable closure extends from adjacent bendable corner B, across bendable corners C and A, and ends before reaching bendable corner D.

9. The blank arrangement of claim 1, wherein the surrounding cardboard wall has a bottom panel.

10. The blank arrangement of claim 1, wherein the liner has a closed bottom between the opposing first and second liner walls.

11. A method of packaging comprising:
(a) providing a relatively flat blank arrangement; the blank arrangement including,
(i) a surrounding cardboard wall enclosing an interior volume; the cardboard wall having parallel front and rear panels, and parallel first and second side panels extending between the front and rear panels; each of the front, rear, first side and second side panels having an interior surface facing the interior volume;
(ii) a tubular liner having an liner exterior surface and opposite liner interior surface; the exterior surface of the liner being attached to the interior surface of each of the front, rear, first side and second side panels; the tubular liner having a first terminal end; the tubular liner having opposing first and second liner walls;
(iii) a mated recloseable closure attached at or adjacent to the first terminal end of only the first liner wall and being free from attachment to the second liner wall;
(iv) the front panel and first side panel have a bendable corner A therebetween; the front panel and the second side panel have a bendable corner B therebetween; the rear panel and the second side panel have a bendable corner C therebetween; the rear panel and the first side panel have a bendable corner D therebetween; bendable corners B and D being at opposite ends of the blank arrangement, with bendable corner C nearer to B than D; and with bendable corner A nearer D than B; and the mated recloseable closure being relatively straight and free of folds from adjacent bendable corner B extending at least partially toward bendable corner D;
(b) bending corners A, B, C, and D to form a rectangular tube with an open interior and an open top and bottom;
(c) forming a closure at the bottom;
(d) providing filling material into the open interior; and
(e) attaching the mated recloseable closure to the second liner wall to close the first terminal end of the tubular liner.

12. The method of claim 11, further including:
after closing the first terminal end of the tubular liner, forming a closure at the top of the rectangular tube.

13. The method of claim 11, wherein the step of providing a relatively flat blank arrangement includes the mated recloseable closure being a recloseable zipper closure having male and female mating profiles.

14. The method of claim 13, wherein the recloseable zipper closure has a slider device attached thereto, constructed and arranged to close and open the zipper closure, as the slider device is moved along the zipper closure.

15. The method of claim 11, wherein the step of providing a relatively flat blank arrangement includes the mated recloseable closure is a hook and loop fastener.

16. A method of using a recloseable package; the method comprising:
(a) providing a closed carton having a liner in an interior of the carton;
(b) opening an end of the carton to access the interior;
(c) opening a recloseable closure on the liner to access contents within the liner; and
(d) closing the recloseable closure on the liner.

17. The method of claim 16, wherein the step of opening the recloseable closure includes opening a recloseable zipper closure.

18. The method of claim 17 wherein the step of opening a recloseable zipper closure includes moving a slider device along the zipper closure.

19. The method of claim 16, wherein the step of opening the recloseable closure includes opening a recloseable hook and loop closure.

20. A package blank for a carton and liner; the package blank comprising:
(a) a surrounding cardboard wall enclosing an interior volume; the cardboard wall having parallel front and rear panels, and parallel first and second side panels extending between the front and rear panels; each of the front, rear, first side and second side panels having an interior surface facing the interior volume;
(b) a tubular liner having an exterior surface and opposite liner interior surface; the exterior surface of the liner being attached to the interior surface of each of the front, rear, first side and second side panels; the tubular liner having a first terminal end and an opposite, second terminal end; the tubular liner having opposing first and second liner walls; and
(c) a mated recloseable closure attached at or adjacent to the first terminal end of the tubular liner, closing the first terminal end; the second terminal end being open.

21. The package blank of claim 20, wherein:
(a) the first side panel having a bendable foldline A dividing the first side panel between a first side panel first section and a first side panel second section;
(b) the second side panel having a bendable foldline B dividing the second side panel between a second side first panel section and a second side panel second section;
(c) the front panel and first side panel first section have a bendable foldline C therebetween;
(d) the front panel and the second side panel first section have a bendable foldline D therebetween;
(e) the rear panel and the first side panel second section have a bendable foldline E therebetween; and
(f) the rear panel and the second side panel second section have a bendable foldline F therebetween;
wherein the package blank is constructed to be relatively flat with bendable foldlines A and B at opposite ends of the package blank, and the mated recloseable zipper closure is relatively straight and free of folds from adjacent bendable foldline A extending completely to bendable foldline B.

22. The package blank of claim 20, wherein the closure is a zipper closure having a slider device attached thereto, constructed and arranged to close the zipper closure, as the slider device is moved in a closing direction along the zipper closure; and open the zipper closure, as the slider device is moved in an opening direction along the zipper closure.

23. The package blank of claim 20, wherein the closure is a press-to-close zipper closure and is slider-free.

24. The package blank of claim 20, wherein the closure is a hook and loop fastener.

25. The package blank of claim 20, wherein the opposing first and second liner walls are separate walls secured together along opposite first and second side seams.

26. The package blank of claim 20, wherein the surrounding cardboard wall has a plurality of upper flaps, foldable into a closeable top; and a plurality of lower flaps, foldable into a closeable bottom.

27. A method of packaging comprising:
(a) providing a relatively flat package blank; the package blank including,
(i) a surrounding cardboard wall enclosing an interior volume; the cardboard wall having parallel front and rear panels, and parallel first and second side panels extending between the front and rear panels; each of the front, rear, first side and second side panels having an interior surface facing the interior volume;
(ii) a tubular liner having an liner exterior surface and opposite liner interior surface; the exterior surface of the liner being attached to the interior surface of each of the front, rear, first side and second side panels; the tubular liner having a first terminal end and an opposite second terminal end; the tubular liner having opposing first and second liner walls;
(iii) a mated recloseable closure attached at or adjacent to the first terminal end of the tubular liner, closing the first terminal end;
(iv) the first side panel having a bendable foldline A dividing the first side panel between a first side panel first section and a first side panel second section;
the second side panel having a bendable foldline B dividing the second side panel between a second side first panel section and a second side panel second section;
the front panel and first side panel first section have a bendable foldline C therebetween; the front panel and the second side panel first section have a bendable foldline D therebetween; the rear panel and the first side panel second section have a bendable foldline E therebetween; and the rear panel and the second side panel second section have a bendable foldline F therebetween;
(b) bending foldlines A, B, C, D, E, and F to form a rectangular tube with an open interior and an open top and bottom;
(c) forming a closure at the top;
(d) providing filling material into the open interior through the open bottom; and
(e) forming a closure at the bottom.

28. The method of claim 27, wherein the step of providing a relatively flat package blank includes the mated recloseable closure being a recloseable zipper closure having male and female mating profiles.

29. The method of claim 28, wherein the recloseable zipper closure has a slider device attached thereto, constructed and arranged to close and open the zipper closure, as the slider device is moved along the zipper closure.

30. A blank arrangement for a carton and liner; the blank arrangement comprising:
(a) a surrounding cardboard wall enclosing an interior volume; the cardboard wall having parallel front and rear panels, and parallel first and second side panels extending between the front and rear panels; each of the front, rear, first side and second side panels having an interior surface facing the interior volume;
(b) a tubular liner having an exterior surface and opposite liner interior surface; the exterior surface of the liner being attached to the interior surface of each of the front, rear, first side and second side panels; the tubular liner having a first terminal end and an opposite, second terminal end; the tubular liner having opposing first and second liner walls; and
(c) a mated recloseable closure attached at or adjacent to the first terminal end of the tubular liner.

31. The blank arrangement of claim 30, wherein the mated recloseable closure is closing the first terminal end, and the second terminal end is open.

32. The blank arrangement of claim 30, wherein the mated recloseable closure is attached to the first terminal end of only the first liner wall and being free from attachment to the second liner wall.
